(19) United States
(12) Patent Application Publication
(10) Pub. No.: US 2001/0047336 A1
(43) Pub. Date: Nov. 29, 2001

(54) Credit card management system

(76) Inventors: Sidney M. Maycock JR., Williamstown, NJ (US); Garrison Y. Pomeroy, Cherry Hill, NJ (US)

Correspondence Address: Stephen J. Weed, Synnestvedt & Lechner LLP, Suite 2600, 1101 Market Street, Philadelphia, PA, 19107-2950, US

(21) Appl. No.: 09/825,092

(22) Filed: Apr. 3, 2001

Related U.S. Application Data
(60) Provisional application No. 60/194,319, filed on Apr. 3, 2000.

(51) Int. Cl. G06F 17/60

(52) U.S. Cl. 705/44

(57) ABSTRACT

A method and system for managing credit card transactions. The method includes obtaining authorization for transactions to be made with a credit card from a credit card account holder, each of the transactions having one or more definable limitations set by the account holder, and authorizing actual transactions initiated with the credit card which conform to the limitation set for the authorized transactions. The system includes a transaction limiter for limiting the approval of actual transactions initiated with a credit card to those conforming to authorized transactions developed by a credit card account holder.

### CROSS-REFERENCE TO RELATED APPLICATIONS

This application is based on, and claims priority to, U.S. Provisional Application No. 60/194,319, filed Apr. 3, 2000, incorporated fully herein by reference.

### FIELD OF THE INVENTION

The present invention relates generally to secure payment systems and, more particularly, the present invention relates to a credit card management system for preventing unauthorized use and fraud.

### BACKGROUND OF THE INVENTION

The use of credit cards for purchasing goods and services has exploded, with a staggering number of credit card transactions performed each day. Given the rapid growth of commerce over the Internet, where credit cards are the preferred method of payment, the number of users and transactions are likely to increase. Credit cards offer convenience to buyers and sellers by facilitating transactions for the purchases of goods and services. Unfortunately, along with the convenience comes the increased exposure to unauthorized transactions and other types of credit card fraud. Accordingly, a system and method for preventing the unauthorized and fraudulent use of credit cards is desirable.

One approach to providing secure credit transactions is proposed in U.S. Pat. No. 6,029,890 (Austin). The approach in Austin involves allowing an account holder to request a unique credit authorization number. The account holder may then use the unique credit authorization number to purchase goods and services. After the purchase is completed, the unique credit authorization number is canceled. This approach requires that the unique credit authorization number be written down or remembered for every purchase, thus imposing an additional burden on the purchaser. The present invention overcomes this burden by seamlessly integrating with existing credit transaction systems in a manner which is transparent to the purchaser.

There has been a long felt need in the credit industry for a method and system to prevent the fraudulent use of credit cards while maintaining existing levels of convenience and ease of use. The present invention satisfies this need among others.

### SUMMARY OF THE INVENTION

The present invention provides a unique method and system for managing credit card transactions. The method for managing credit card transactions includes obtaining authorization for one or more transactions made with a credit card, with the authorization including one or more limitations selected by a credit card account holder, and approving an actual transaction initiated with the credit card when the actual transaction includes parameters conforming to the limitations of the authorized transaction. The system includes a transaction limiter which receives transaction parameters from a credit card account holder for transactions to be authorized for a credit card and instructs authorization to be made for actual transactions initiated with the credit card which conform to the transaction parameters selected by the credit card account holder.

By permitting the credit card account holder to “preauthorize” transactions, the present invention provides a novel method and system for managing credit card transactions which prevents unauthorized use and fraud while maintaining existing levels of convenience and ease of use. Accordingly, the present invention will be particularly useful to consumers, businesses, credit providers, and retailers.

### BRIEF DESCRIPTION OF THE DRAWINGS

FIG. 1 is a block diagram illustrating a credit card management system in accordance with the present invention;

FIG. 2 is a block diagram illustrating of a preferred embodiment for implementing a credit card management system in accordance with the present invention;

FIG. 3 is a flow chart depicting the authorization of an actual transaction in accordance with the present invention; and

FIG. 4 is a flow chart depicting the creation of an authorized transaction by a credit card account holder in accordance with the present invention.

### DETAILED DESCRIPTION OF THE INVENTION

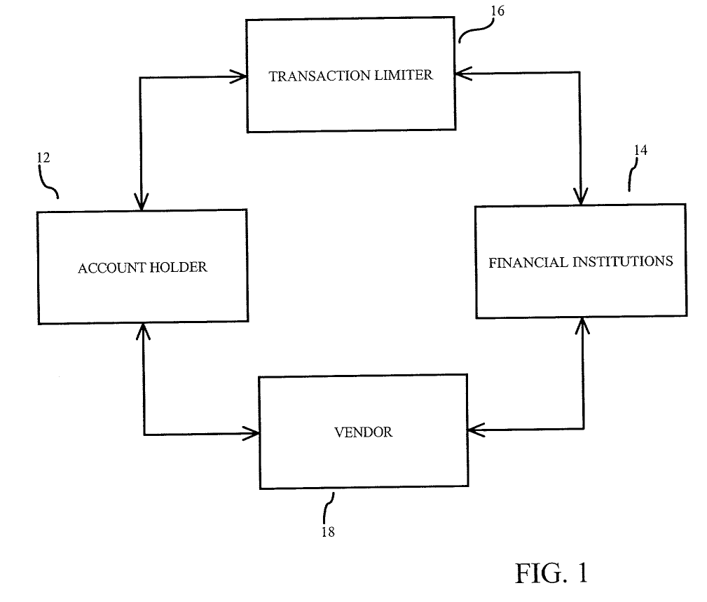

FIG. 1 is a block diagram 10 illustrating a credit management system in accordance with the present invention. The credit management system includes a transaction limiter 16 which enables an account holder 12 to create an authorized transaction having definable parameters (e.g., maximum dollar amounts, validity at specific vendors, validity at specific types of vendors). The authorized transaction is then used by traditional financial institutions 14 (e.g., credit card companies and credit clearing houses) to limit the approval of payments to vendors 18 to actual transactions initiated with a credit card which conform to the authorized transactions.

The account holder 12 is a credit card account holder 12 or an authorized representative of the credit card account holder 12. The credit card account holder 12 maintains an account with a financial institution 14 (e.g., credit card company). Each account has a credit card number associated with it which may be used in a conventional manner to purchase goods and services from a vendor 18.

The vendor 18 is a conventional vendor of goods or services which is able to accept credit cards as payment for its goods or services. When a good or service is purchased from a vendor 18 with a credit card, the vendor 18 submits the number of the credit card along with transaction information to the financial institutions 14 for payment authorization.

The financial institutions 14 maintain the credit card holder's account and process payment requests from the vendor 18. In addition, in accordance with the present invention, the financial institutions 14 receive authorized transaction information from the transaction limiter 16, and limit the authorization of payment to the vendors 18 to actual transactions which conform to the authorized transactions. In a preferred embodiment, the financial institutions 14 comprise a bank/credit provider and a credit clearing house. Banks/credit providers and credit clearing houses, and their interaction with one another to permit the authorization of payments to vendors 18, are well known in the art.

The transaction limiter 16 retrieves information related to the account holder's account from the financial institutions 14 and provides selectable criteria for allowing an account holder to create authorized transactions. In addition, the transaction limiter 16 passes authorized transaction information to the financial institutions 14. The account information is obtained from the financial institutions 14 and is, preferably, used to limit the selectable criteria (e.g., preventing the account holder from creating authorized transactions which exceed the account holder's available credit). In a preferred embodiment, the account holder 12 preauthorizes transactions by specifying criteria selected from criteria available at the transaction limiter 16, and the transaction limiter 16 then transmits the authorized transactions to the financial institutions 14.

In a preferred embodiment, the function of the transaction limiter 16 is performed by an independent business entity. In an alternative embodiment, the transaction limiter functions are performed by the financial institutions 14.

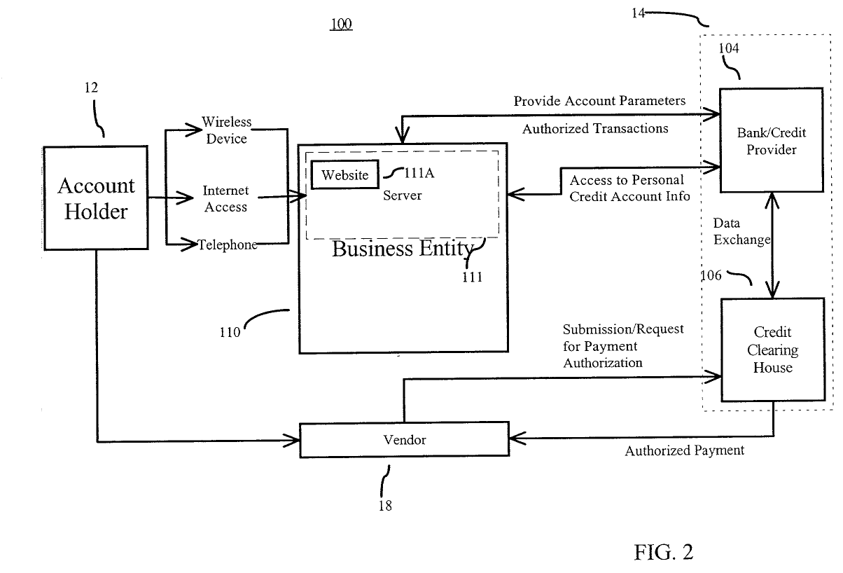

FIG. 2 is a block diagram illustrating a preferred embodiment of the present invention. In FIG. 2, a credit card account holder 12 with a credit card account at a bank/credit provider 104 would like to purchase a good or service at a vendor 18. Through a business entity 110, the credit card account holder 12 creates authorized transactions with which an actual transaction initiated with a credit card at a vendor 18 must conform in order for payment to be authorized to the vendor 18 by conventional financial institutions 14. The business entity 110 is a company established to carry out the functions of the transaction limiter 16 (FIG. 1).

In order to purchase goods or services, the credit card account holder 12 supplies the credit card number of the credit card to the vendor 18 and the vendor 18 generates an actual transaction by sending the credit card number and information related to the purchase (e.g., purchase amount, store identification number, etc.) to a credit clearing house 106. The credit clearing house 106 contacts the bank/credit provider 104 that backs the credit card account holder's account to determine if the actual transaction should be allowed. The bank/credit provider 104 compares the actual transaction to authorized transactions received from the business entity 110. If the actual transaction conforms to all of the limitations of an authorized transaction as created by the account holder 12, the bank/credit provider 104 will approve the transaction. The approval will be transferred through the credit clearing house 106 and authorization will be indicated to the vendor 18. The vendor 18 will then release the goods or services to the credit card account holder 12.

The conventional financial institutions 14 include a bank/credit provider 104 and a credit clearing house 106. In a preferred embodiment, billing by the bank/credit provider 104 to the credit card account holder will remain virtually the same with purchase references easily matched to customer transaction accounting systems. Preferably, payments to the bank/credit provider 104 from the credit card account holder 12 can be made electronically from a website 111A of the business entity 110, and at the end of a billing cycle, a complete report may be made available to the credit card account holder 12 at the website 111A.

Preferably, the business entity 110 maintains a server 111 which is accessible through one or more communication networks. In the preferred embodiment, the server 111 permits a web page to be displayed at a website 111A on the Internet for access by the account holder 12. Alternatively, the account holder 12 may access the server 111 through an ATM, personal digital assistant (PDA), wireless device, telephone connection, or essentially any communication medium. Preferably, the account holder 12 can access the business entity's website 111A at their convenience to authorize additional transactions via a computer, wireless device, or telephone using customer access codes and passwords. In certain preferred embodiments, voice activated prompts may be employed for customer convenience.

The business entity 110 interfaces with the financial institutions 14 to obtain account information and supply authorized transactions created by the account holder 12. In a preferred embodiment, all transactions on a credit card account are reported to the business entity 110 by the financial institutions 14 for the purpose of accurate balance information and to assure that the credit card is not being used fraudulently. This enables account holders to closely manage their credit card accounts, thereby alleviating fear of using their credit cards for electronic/digital commerce, fax transfers of credit card account information, Internet commerce, telephone purchases as well as all other forms of credit card commerce.

In the preferred embodiment, the business entity 110 employs all current and existing electronic tracking and accounting information for a credit card account in addition to the credit management features of the present invention. Once the bank/credit provider 104 sets a customer's credit limit, and that information is communicated to the business entity 110, the business entity 110 enables account holders 12 to set their own spending limits (within the limit set by the bank/credit provider 104) on a per transaction basis as well as being the approval source for every transaction within their set limits. Preferably, once the account holder's preset limit is met, the credit card remains valid but with no available credit until such time that the account holder 12, or an authorized agent, resets the available credit through the website 111A of the business entity 110. Attempts to use the credit card for actual transactions prior to creating an authorized transaction results in the transaction being declined.

In addition, in the preferred embodiment, the business entity 110 incorporates software which is written and encoded to interface with the already existing international credit card infrastructure. This simplifies the deployment of the present invention and standardizes its application. The development of software to permit the business entity to interface with the existing international credit card infrastructure will be readily apparent to those skilled in the art.

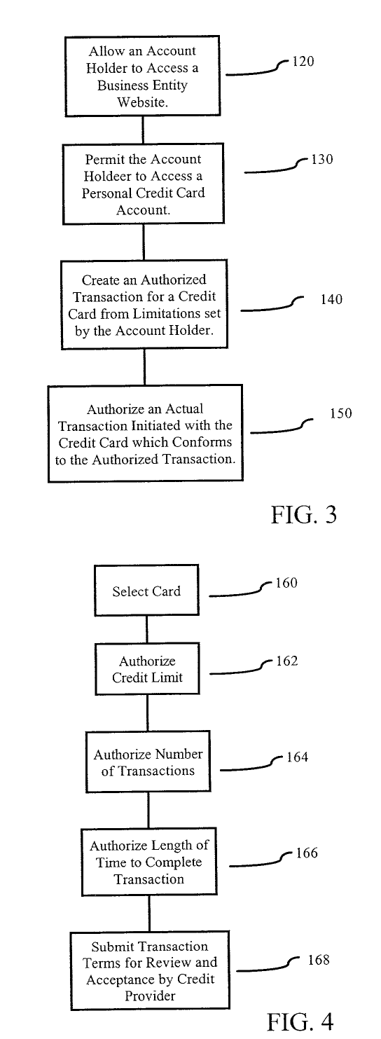

In use, the apparatus depicted in FIGS. 1 and 2 can be used to perform the steps depicted in the flow chart of FIG. 3. The steps depicted in FIG. 3 enable the creation of an authorized transaction by an account holder, or authorized representative, in accordance with the present invention. The steps comprise allowing access to a business entity web site by a credit card account holder, permitting the credit card account holder to access personal credit card account information, creating an authorized transaction from limitations set by the credit card account holder, and authorizing actual transactions which conform to the limitations of the authorized transaction. The authorized transaction can then be used by conventional financial institutions to approve actual transactions initiated with the credit card for a vendor's goods and services.

At step 120, an account holder (or authorized representative) is allowed access to a business entity server. Preferably, the account holder accesses a web page displayed by the server via the Internet.

At step 130, the account holder is permitted access to personal credit card account information. In the preferred embodiment, the account holder enters security information (e.g., a user name and password) to gain access to their personal credit card account.

At step 140, the account holder creates an authorized transaction. The authorized transaction is created from limitations set by the account holder. In the preferred embodiment, the account holder selects limitations on a web page maintained by the business entity and displayed by the business entity's server via the Internet.

At step 150, the business entity authorizes an actual transaction initiated with a credit card for goods and services purchased at a vendor which conform to the limitations of the authorized transaction set by the account holder. Purchases which fall within the authorized transaction are completed with the vendor receiving an authorization code for payment and the credit card holder receiving the good or service from the vendor, and transactions falling outside of the authorized transaction are declined.

FIG. 4 depicts the steps involved in allowing an account holder to enter limitations used to create an authorized transaction as described in reference to FIG. 3. In the preferred embodiment, an authorized transaction is created by allowing an account holder to select a credit card account, authorize limitations, and submit the limitations for review and acceptance by a credit provider.

At step 160, a credit card account is selected by the account holder. In a preferred embodiment, the credit card account is selected by an account holder at a business entity's website using conventional website selection devices (e.g., scroll bars, displayed lists, drop down menus, etc.). For example, a Master Card credit card number and a Visa credit card number could both be displayed on a drop down menu when the account holder accesses the website. The account holder would then select the desired credit card account number with a pointer device (e.g., a mouse).

At step 162, the account holder authorizes a credit limit for an authorized transaction. In a preferred embodiment, the account holder enters the credit limit at the business entity website by entering a dollar amount into an input box or selecting a dollar amount from among a plurality of dollar amounts listed in a drop down menu. For example, an account holder who is attempting to purchase an item which costs $325.00 would enter an authorized credit limit of $325.00. In the example, a vendor that submitted a bill which was greater then $325.00, e.g., $350.00, would be declined payment.

At step 164, the account holder authorizes the number of transactions to be performed. Using conventional means, the account holder selects either a single vendor, a specified number of vendors or an unlimited number of vendors. For example, if a user desires to purchase a single product from a single vendor, the user would select a single vendor. In this example, the first vendor to submit for payment would receive payment and all subsequent vendors would be denied payment, thereby limiting exposure to the single transaction.

At step 166, the account holder authorizes the length of time to complete a transaction. For example, the account holder may select that the transaction is good for the remainder of a calender day, the transaction is good until further notice, or the transaction is good until that transaction is performed.

At step 168, the authorized transaction for a specific card having limitations selected by the account holder is submitted for review and acceptance by the credit provider. For example, if the credit limit for an authorized transaction is greater than the credit available on the credit card, the transaction would not be accepted and the account holder would be required to modify the authorized transaction. If everything within the authorized transaction conforms to the current limitations of the account holder's credit card, the authorized transaction would be accepted by the credit provider.

Potential applications of the present invention include, but are not limited to, the following:

Allowing a parent/account holder to permit the use of the credit card by a child for convenience with confidence that the card will not be used for any purposes other than what has been agreed to and authorized by the account holder. In addition, vendor errors or duplication of charges may be reduced through the use of the present invention.

Allowing an employer/card holder to determine what expenses will be authorized prior to use of a company credit card or other expense account card. This greatly reduces unanticipated expenses, card abuse, or unauthorized purchases. This enables the employer to be in control of the travel budget before, not after, business usage of the card.

Allowing a credit card account holder to specify the maximum amount that a specified retailer is allowed to charge a credit card for a specified period of time. For example, the credit card account holder could limit the approval of a credit card transactions at Amazon.com to $25.00 for a period of two days. This allows a $20.00 book to be purchased without worrying about Amazon.com charging more to the credit card than $25.00, Amazon.com charging the credit card again a week later, or another company charging any amount to the credit card.

Allowing a credit card account holder to specify the maximum amount for a specified period of time. For example, the credit card account holder could limit the approval of all transactions to the credit card within an eight hour period to a total of $250.00 without specifying a specific vendor. This allows the credit card account holder to go to a dinner and a movie without worrying about a $1000.00 stereo being charged by someone who has come in contact with the credit card within the specified eight hour period.

Allowing a credit card account holder to specify a certain dollar amount for one provider and another dollar amount for another provider. For example, the credit card account holder could specify a maximum amount for a university tuition office and specify another amount for a campus book store. This allows a relative of the credit card account holder to charge tuition and books for a semester to the credit card while preventing frivolous expenditures. The approval could be structured so that books could be purchased on more than one occasion until the specified maximum dollar amount is reached, thereby allowing periodic trips to the book store throughout the semester.

Allowing a credit card account holder to individually specify different account maximums for each family member. For example, the credit card account holder could specify that transactions would be unlimited for adults in the household and children would have a $100 maximum per month. Each member of the household would be assigned a unique identifier, such as a credit card with a different last four digits, that would access the account of the account holder. This allows the credit card account holder to have unrestricted access to a credit card account while being able to teach a child how to properly use a credit card by imposing transaction restrictions.

Allowing consumers to access their credit card accounts and predetermine limits prior to making purchases. In a preferred embodiment, consumers will be able to briefly visit a business entity's website over the Internet to preset their expected expenditures. After the consumer has spent the allocated funds, the card shall remain valid but have an available credit limit of zero. This will make unauthorized use of the card impossible.

Allowing a bank to send a customer a new card which can be easily activated. Instead of being instructed to call a telephone number for activation of the card, the account holder will be given the choice of activating the card from the website of the business entity. Preferably, the credit card account holder will be given a user ID and a password which will open their personal online account. The card activation information and credit limits will be available to them at the business entity's website. Upon activation, there will be instructions which will familiarize the customer with the process of using the business entity's website and the advantages, thereby encouraging usage.

Allowing an account holder who loses a card to go to the business entity's website and set the available credit to zero to temporarily suspend usage while determining if the card has been lost or simply misplaced. In the event the card is found, the account holder avoids personal aggravation and expense to the bank. In the event the card has been lost or stolen, the card can be canceled at the business entity's website and a request for a new card can be made.

Additional items which may be used to restrict authorized transactions may include, but are not limited to: specifying that transactions from only specified locations, such as cities or states, are authorized to be charged to a credit card; specifying that transactions from only a specific type of store, such as clothing stores or book stores, are authorized to be charged to a credit card; or specifying negative limitation, such as no liquor store or restaurant transactions, are authorized to be charged to a credit card.

Having thus described a few particular embodiments of the invention, various alterations, modifications, and improvements will readily occur to those skilled in the art. For example, it will be readily apparent to those skilled in the art that the present invention can apply to credit cards, debit cards, on-line transactions, or essentially any non-cash type of transaction. In addition, many additional types of user definable limitation could be implemented in accordance with the present invention. Also, the system may be accessed through the Internet, telephone, personal digital assistant (PDA), automatic teller machine, or essentially any communication means. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A credit card management method comprising the steps of:
obtaining authorization for one or more transactions with a credit card from a credit card account holder, each of said authorized transactions having one or more definable limitations set by said credit card account holder; and
approving an actual transaction initiated with said credit card when said actual transaction comprises parameters conforming to said one or more definable limitations.

2. The method of claim 1, further comprising the step of:
removing said authorization after a predefined period of time, such that said actual transaction will not be approved after said predefined period of time.

3. The method of claim 1, wherein said one or more definable limitations comprise at least one of a maximum dollar amount, a specific vendor, a type of vendor, a number of transactions, and a time period.

4. The method of claim 1, wherein said step of obtaining preauthorization comprises receiving preauthorization instructions initiated by said credit card account holder.

5. The method of claim 4, wherein said step of receiving preauthorization is communicated via a network.

6. The method of claim 5, wherein said network is the Internet.

7. A credit card management system comprising the steps of:
allowing a credit card account holder to access a website of a business entity for managing credit card transactions;
permitting the credit card account holder to access personal credit card account information;
creating an authorized transaction for a credit card from limitations set by the credit and account holder; and
authorizing an actual transaction initiated with the credit card that conforms to the limitations of said authorized transaction.

8. The method of claim 7, wherein said step of creating an authorized transaction comprises the steps of:
setting definable limitations, said definable limitations set by said credit card holder; and
submitting said definable limitations for review and acceptance by a credit provider.

9. The method of claim 8, further comprising the step of:
removing said authorization after a predefined period of time, such that said actual transaction will not be approved after said predefined period of time.

10. The method of claim 8, wherein said one or more definable limitations comprise at least one of a maximum dollar amount, a specific vendor, a type of vendor, a number of transactions, and a time period.

11. The method of claim 8, wherein said step of creating an authorized transaction comprises receiving authorization instructions initiated by said credit card account holder.

12. The method of claim 11, wherein said step of creating an authorized transaction is communicated via a network.

13. The method of claim 12, wherein said network is the Internet.

14. A credit management system for managing credit card transaction approval by financial institutions, said credit management system comprising:
a transaction limiter, said transaction limiter permitting access by a credit card account holder to personal account information from the financial institutions, allowing the credit card account holder to create at least one authorized transaction, each of said authorized transactions having at least one parameter selected by the credit card account holder, and passing said at least one authorized transaction to the financial institutions for approving an actual transaction submitted by a vendor that conforms to said at least one authorized transaction.

15. The credit management system of claim 14, wherein the financial institutions comprise at least a credit card provider and a credit clearing house, said transaction limiter interfacing with said credit provider to supply said authorized transaction to said credit clearing house via said credit provider.

16. The credit management system of claim 15, wherein said transaction limiter is incorporated within said credit card provider.

17. The credit management system of claim 14, wherein said transaction limiter comprises a server.

18. The credit management system of claim 17, wherein a website is maintained on said server, said website allowing said credit card account holder to interface with said transaction limiter via the Internet.

19. The credit management system of claim 14, wherein said transaction limiter is an independent business entity.

20. The credit management system of claim 14, wherein said transaction limiter is incorporated within said financial institutions.
